(19) United States
(12) Patent Application Publication
(10) Pub. No.: US 2024/0025517 A1
(43) Pub. Date: Jan. 25, 2024

(54) OFFSHORE ENERGY GENERATION SYSTEM

(71) Applicants: Leonardo Do Valle Fehlberg, Neuss (DE); Javier Ricardo Castillo, Katy, TX (US)

(72) Inventors: Leonardo Do Valle Fehlberg, Neuss (DE); Javier Ricardo Castillo, Katy, TX (US)

(21) Appl. No.: 18/480,559

(22) Filed: Oct. 4, 2023

Related U.S. Application Data
(63) Continuation-in-part of application No. 17/162,149, filed on Jan. 29, 2021.

(51) Int. Cl. B63B 35/44; G21D 1/00; G21C 11/04; G21C 15/18

(52) U.S. Cl. CPC B63B 35/44; G21D 1/00; G21C 11/04; G21C 15/18; B63B 2035/4446

(57) ABSTRACT

Disclosed is an offshore energy generation system (OEGS) that eliminates greenhouse gas emissions during operation, mitigating earthquake and tsunami impacts, and nuclear meltdown safety. The OEGS comprises a floating facility configured for dynamic positioning to a target site via a system that is communicably coupled to the floating facility. The floating facility is coupled to seawater collection system; steam generation system; electric power generation system that uses at least one of: steam, nuclear fission, nuclear fusion or hydrogen fuel cells for generating electric power; ammonia, freshwater, nitrogen and hydrogen generation systems, cooling water system, electric power, freshwater, and ammonia export systems, multiple offshore cranes, living quarters and helideck; automation, control and safety system for controlling one or more components. The OEGS is effective, affordable and a reliable solution for climate change as it delivers clean energy in the form of electricity, ammonia and/or freshwater.

### TECHNICAL FIELD

The present disclosure relates to an offshore energy generation system, for delivering clean energy in the form of electricity, ammonia, hydrogen (H₂) and/or freshwater.

### BACKGROUND

Considering that the intergovernmental panel on climate change (IPCC), from the United Nations, is calling for a net zero challenge; that require a step change in technology innovation in critical areas such as making low-carbon electricity the main source for manufacturing, heating buildings and powering vehicles, capturing, storing and utilizing carbon dioxide before it escapes into the atmosphere, realizing the potential of clean Hydrogen across many industries, and massively expanding the use of sustainable bioenergy.

Considering that to accomplish this challenge it will be necessary to increase our worldwide energy supply to about 50% more than that was being produced in 2018; and at the same time execute a major decarbonization of entire economies worldwide to reduce the carbon emission to the atmosphere to levels that ensure a secure environment. This will require the rapid development of many technologies that are still in their very early stages today—some of them are barely out of the laboratory. Recent IEA (International Energy Agency) analysis has assessed the market readiness of 400 different technologies that will be needed, but finds that only about half of the additional emissions savings needed to reach net-zero emissions by 2050 are available to the market today.

Considering the urgency of this call to action, the authors performed a very detailed and systematic analysis of all the current technologies available for power generation and storage. Utilizing their extensive project management, engineering experience and business mindset as the foundation; as well as market analysis from the customer perspective to provide a best-in-class solution to address the climate challenge.

Currently, about 13% (940 million) of the world population does not have access to electricity; about 11% (840 million) of the world population does not have access drinking water and about 40% (3 billion) of the world population does not have access to clean fuels for cooking. This comes at a high health cost for indoor air pollution. Based on current forecasts about 25% of the world population will likely live in a country affected by chronic or recurring freshwater shortages.

The total area of the world ocean is about 361.9 million square kilometers (139.7 million square miles), which covers about 70.9% of Earth's surface and there are about 620,000 kilometers (372,000 miles) of coastline on the Earth. Over one-third of the total human population, nearly 2.4 billion people, lives within 100 km (60 miles) of an oceanic coast.

Chinese patent CN105059489A describes a constantly stable offshore nuclear power platform, that is limited to the generation of electricity and water desalinization; and it is not characterized to produce zero carbon emissions. The claims on the patent CN105059489A are mainly centered in hull components.

Chinese patents CN104960637A (Offshore nuclear power platform for shallow ice sea regions) and CN104960637B (A type of marine nuclear power platform for shallow water ice formation marine site) relates to an offshore nuclear power platform for shallow ice sea regions.

U.S. Pat. No. 9,443,620B2 (Reactor containment vessel and nuclear power plant using the same) is related and limited to the specific design of a nuclear reactor.

The Chinese patents CN105501404A (Oversea floating type nuclear power generating device of polygonal structure), CN104264646A (Concrete marine nuclear power platform) and CN204252096U (The marine nuclear power platform of a type of concrete) are related to specific geometry like the polygonal structure defined in the CN105501404A or the concrete materials used on the CN104264646A and CN204252096U.

The international patent WO2015147952A3 (Floating nuclear power reactor with a self-cooling containment structure and an emergency heat exchange system) and the U.S. Pat. No. 7,331,303B2 (Floating power plant) claim a specific type of nuclear reactor meanwhile. The WO2015147952A3 floating nuclear power reactor includes a self-cooling containment structure and an emergency heat exchange system.

The Chinese patent CN204066759U (A type of nuclear power station of removable marine nuclear power platform) describes a specific nuclear platform design that has a removable caisson.

The U.S. Pat. No. 10,269,462B2 (Semi-submersible nuclear power plant and multi-purpose platform) scope includes a nuclear power plant that is integrated into the submerged hull of an offshore, floating spar or cell spar platform. Furthermore, the patent U.S. Pat. No. 10,269,462B2 is also limited to generating electricity and ancillary services for its own use like desalinated water.

The International Patent WO2010/096735A1 (Offshore energy carrier production plant) and the US patent US20140140466A1 (Semi Submersible Nuclear Power Plant and Multipurpose Platform) for the offshore energy carrier is a nuclear fission plant intended to produce and dispatch energy carriers from hydrogen to hydrocarbons such as methanol and jet fuel.

The U.S. Pat. No. 4,302,291A (Underwater nuclear power plant structure) comprises a triangular platform formed of tubular leg and truss members upon which are attached one or more large spherical pressure vessels.

There have been multiple floating nuclear facilities constructed since the 1960's when the US Army commissioned the Sturgis as the first floating nuclear power plant. But none of these facilities have the unique characteristics to meet the currently desired environmental benefits, such as zero carbon emissions, clean freshwater and ammonia as energy carrier for the hydrogen. Moreover, installation of the existing facilities is inefficient in areas with extreme wind and current forces, or unknown depth of water levels.

Therefore, in the light of the foregoing discussion, there exists a need to overcome the aforementioned drawbacks.

### SUMMARY

The aim of the present disclosure is to provide an offshore energy generation system that is the solution for the net zero challenge for producing clean energy, in the form of electricity and/or freshwater and/or Ammonia (NH₃) as energy carrier for Hydrogen (H₂) and/or Hydrogen (H₂) while combating the extreme wind and current forces thereon. The aim of the present disclosure is achieved by an offshore energy generation system that is flexible to provide all the four products: electricity, freshwater, Ammonia (NH₃) and Hydrogen (H₂) or any combination of one, two, three or four of them according to the customer requirements while being effectively, dynamically positioned at target sites that experience a wide range of environmental impacts, as defined in the appended independent claims to which reference is made to. Advantageous features are set out in the appended dependent claims.

In a first aspect, the present disclosure provides an offshore energy generation system, according to claim 1. the disclosed floating facility may be kept (namely, maintained) at the target site, such as a seabed portion or a maintaining station via a dynamic positioning system (selected from Dynamic Positioning System class 1, (DP1), Dynamic Positioning System class 2 (DP2), Dynamic Positioning System class 3 (DP3), Dynamic Positioning System class 4 (DP4), etc.). In this regard, the offshore energy generation system could be outfitted with a dynamic positioning system comprising multiple azimuth thrusters and a control system based on the global positioning system technology (GPS) with the intention to keep the offshore energy generation system on the pre-determined location (geographical coordinates). The main advantages of the dynamic positioning system are the ability to evade weather disturbances (for example hurricanes, tsunami, typhoon and others) and reduced in-field installation time to start the operation. Such dynamic positioning systems can be found installed on the latest generation of drillship that the offshore drilling industry utilized for their operations.

The offshore energy generation system consists of a ship-shaped floating facility or a semi-submersible platform floating facility or a spar platform floating facility dynamically positioned via a dynamic positioning system selected from Dynamic Positioning System class 1 (DP1), Dynamic Positioning System class 2 (DP2), Dynamic Positioning System class 3 (DP3), Dynamic Positioning System class 4 (DP4), etc., with the offshore energy generation system required to deliver electricity and/or freshwater and/or Hydrogen (H₂) and/or Nitrogen (N₂) and/or Ammonia (NH₃) to be exported to shore or other offshore or subsea systems via submerged electrical power export lines (cables) and/or pipelines, and/or offshore supply vessels, as applicable. Typically, other offshore or subsea systems include offshore oil and gas production systems, e.g., spars, semi-submersible, FPSO (Floating, Production, Storage and Offloading) or similar; offshore marine terminals, ports, industrial or recreational parks, offshore and/or underwater computer data centers, aerospace offshore facilities, offshore fish and food processing, etc.

Beneficially, the offshore energy generation system responds effectively to the climate challenge and freshwater scarcity, the need for clean liquid fuels; but it also enables a better land management and urban planning and development. Additionally, the offshore energy generation system could accelerate the development of many coastlines that are currently deserted as they are isolated due to lack of freshwater; or the coastline is used for existing oil refineries, coal facilities and other facilities that could be transitioned into other uses to satisfy the needs of the society.

The offshore energy generation system is a dynamically-positioned floating system that will operate in a similar way as an offshore oil and gas producing system, with crews manning the offshore energy generation system 24 hours. In this regard, in addition to freshwater and energy generation systems (namely, electric power, ammonia, hydrogen and nitrogen generation systems), the offshore energy generation system also comprises accommodation facilities, helipad and/or boat landing for crew transport, cranes for handling material and people to and from the supply boat, life-saving equipment, electronic connectivity to the outside world and other systems.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a high-level schematic process view of an offshore energy generation system;

FIG. 2 illustrates a schematic profile view of main components of an offshore energy generation system moored using spread mooring;

FIG. 3 illustrates a schematic plan view of main components of an offshore energy generation system, moored using spread mooring;

FIG. 4 illustrates a schematic profile view of main components of an offshore energy generation system, moored using a turret equipment; and

FIG. 5 illustrates a schematic plan view of main components of an offshore energy generation system, moored using a turret equipment.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides an offshore energy generation system comprising:
a floating facility configured for dynamic positioning at a target site, the floating facility is coupled with
   a seawater collection system arranged on the floating facility and configured for collecting a volume of seawater;
   a steam generation system, operatively coupled with the seawater collection system, configured for generating steam from the volume of seawater collected by the seawater collection system;
   an electric power generation system, operatively coupled with the steam generation system, configured for generating electric power by using at least one of: the steam generated by the steam generation system, a nuclear fission, a nuclear fusion, a hydrogen (H2) fuel cell;
   a freshwater generation system, operatively coupled with the seawater collection system and the steam generation system, configured for distilling freshwater by using the volume of seawater collected by the seawater collection system and a residual thermal energy generated by the steam generation system;
   a hydrogen (H2) generation system, operatively coupled with the freshwater generation system and the electric power generation system, configured for generating hydrogen by using the distilled freshwater from the freshwater generation system and the electric power generated by the electric power generation system;
   a nitrogen (N2) generation system, operatively coupled with the electric power generation system, configured for generating nitrogen by using compressed air from an air supply unit and the electric power generated by the electric power generation system;
   an ammonia generation system, operatively coupled with the electric power generation system, the hydrogen (H2) generation system and the nitrogen (N2) generation system, for configured generating ammonia by using the hydrogen (H2), the nitrogen (N2) and the electric power generated by the hydrogen generation system, the nitrogen generation system and the electric power generation system, respectively;
   a cooling water system, operatively coupled to the electric power generation system and the seawater collection system, configured for supplying the volume of seawater collected by the seawater collection system to the electric power generation system;
   an electric power export system, operatively coupled to the electric power generation system, configured for exporting the generated electric power;
   a freshwater export system, operatively coupled to the freshwater generation system, configured for exporting the distilled freshwater;
   an ammonia export system, operatively coupled to the ammonia generation system, configured for exporting the generated ammonia;
   multiple offshore cranes arranged on the floating facility;
   living quarters arranged on the floating facility;
   a helideck arranged on the floating facility; and
   an automation, control and safety system for controlling one or more components of the offshore energy generation system; and
a dynamic positioning system, communicably coupled to the floating facility, for positioning the floating facility at the target site.

The present disclosure provides the aforementioned offshore energy generation system that is configured to deliver clean energy in the form of electricity and/or ammonia (NH3) and/or freshwater and/or hydrogen, to offshore or onshore consumers. The offshore energy generation system is effective, affordable and reliable solution for the global climate change and the freshwater scarcity crisis. Beneficially, by deploying the disclosed offshore energy generation system across the world, the net zero emissions targets from IPCC can be achieved and the water scarcity crisis can be mitigated. Additionally, the offshore energy generation system enables better safety of the population served, optimal use of land, the protection of the world cultural heritage and eliminates land use conflicts.

Moreover, the offshore energy generation system design philosophy is from the customer perspective and delivers unique functionality, superior safety, reliability, flexibility, low-cost clean electrical energy, freshwater and ammonia. The offshore energy generation system generates no greenhouse gases and no carbon-based products during its normal operations or through the products it delivered. The offshore energy generation system leverages on the existing laws of physics instead of trying to oppose them as other prior art.

In an embodiment, the offshore energy generation system is implemented as a ship-shaped floating offshore energy generation system. In this regard, the offshore energy generation system is shaped, wholly or at least partly as a ship, such as for example, comprising features such as a hull, a keel, a prow, and a stern, that assist in the offshore energy generation system in being capable of floating in water and moving through it. Typically, the term “ship-shape” may refer to a long, narrow profile which may be curved or angled with a pointed or rounded bow (front) region and a wider stern (rear) region. Moreover, the offshore energy generation system is fabricated from materials that are resistant to damage from water. It will be appreciated that the ship-shape structure may include a boat shape, a yacht shape, a cruise ship shape, a cargo ship shape and a submarine shape. It will be appreciated that specific dimensions, proportions, or design features defining the ship-shape may vary and depend on specific applications thereof. In another embodiment, the floating facility may be designed as a semi-submersible platform floating facility or a spar platform floating facility. Notably, the semi-submersible platform floating facility or the spar platform floating facility designs enable installations in deeper waters where traditional fixed platforms are not feasible. Typically, the semi-submersible platform floating facility features multiple hulls or pontoons submerged beneath the water's surface, connected to a topside structure above the waterline. The semi-submersible platform floating facility design provides stability by utilizing the buoyancy of the submerged hulls to counteract wave and wind forces, while the topside houses the living quarters, equipment, and energy generation components. Beneficially, the semi-submersible platform floating facility is configured for easy towing to different locations, making them suitable for temporary installations or projects with changing requirements. Additionally, the semi-submersible platform floating facility can operate in a range of water depths, making them adaptable to various offshore environments. The spar platform floating facility is typically a cylindrical floating structure with a large-diameter vertical column extending deep underwater, anchored to the seabed. The spar platform floating facility's buoyancy is provided by the submerged column, while the topside contains the energy generation or production equipment. Beneficially, the spar platform floating facility are well-suited for deep water applications. Additionally, the vertical design of the spar platform floating facility minimizes its surface area thus making its application suitable in areas with limited space or high currents. It will be appreciated that selection of the implementation design of the floating facility is dependent on factors selected from at least one of: as water depth, environmental conditions, project requirements, stability, operational flexibility, installation feasibility, project economics.

Pursuant to an embodiment, floating facility is configured for dynamic positioning at a target site. Typically, dynamic positioning (DP) is a technology used in the maritime and offshore industries to automatically control the position and heading of a vessel, platform, or other floating structure (such as the floating facility of the OEGS) relative to a specific GPS coordinate or reference point in the water column. Notably, the dynamic positioning is controlled by a dynamic positioning (DP) system that is configured to maintain a specific location, heading, or both, without the need for traditional anchoring or mooring. Typically, the DP system enables a vessel or offshore structure to maintain a precise position and orientation, even in challenging environmental conditions such as strong currents, wind, and waves. This technology is particularly important for tasks such as offshore drilling, subsea construction, cable laying, and underwater exploration, where precise positioning is critical. The floating facility remains in the same location utilizing the state-of-art dynamic positioning system, similarly to what the latest generation of drillship are outfitted with. In this regard, optionally, the offshore energy generation system could be outfitted with a dynamic positioning system. Such dynamic positioning system comprises of azimuth turrets and control system based in the global positioning system (GPS). The selection of such system is based on: design preferences, weather patterns and/or regulatory demands. DP system employs a combination of sensors, computers, and thrusters and/or propellers of the floating facility to maintain the position and heading of a vessel or offshore platform at a specific point in open water, away from fixed structures or the seabed portion.

Optionally, the dynamic positioning system comprises position reference sensors, environmental sensors, one or more processors, a control arrangement, and a monitoring system. Typically, one or more position reference sensors are used for accurate positioning and navigation based on signals from satellites. Optionally, the one or more position reference sensors employ global positioning system (GPS), differential GPS (DGPS), or other technologies, to accurately determine position of the OEGS and allow for an accurate navigation thereof or make adjustments as required. The position reference sensors are coupled with the environmental sensors to enhance the efficacy of dynamic positioning by the DP system. The environmental sensors typically gather real-time data about the OEGS position and motion. The environmental sensors include, but do not limit to, wind sensors, motion sensors, gyrosensors (or gyroscope), GPS receivers, accelerometers, depth sensors. The one or more processors are configured to process the data received from the position reference sensors and the environmental sensors.

Optionally, the one or more processors is configured to implement an algorithm thereon, to control a positioning of the floating facility via thrusters and/or propellers corresponding to the floating facility, based on a mathematical model of the floating facility. The algorithm is configured to calculate the deviations (if any) in the OEGS positioning, heading and navigation and make required changes to maintain the desired positioning, heading and/or navigation, based on the mathematical model of the floating facility. The mathematical model includes a current position of the floating facility, location of the thrusts and/or propellers on the floating facility, and external forces like wind and waves and velocity thereof. The one or more processors is configured to control the positioning of the floating facility via thrusters and/or propellers corresponding to the floating facility by for example changing the steering angle and/or thruster output for each thruster. Optionally, the one or more processors use a joystick or other suitable control interfaces to control the OEGS's position, heading and navigation, when needed. The monitoring system is typically used to generate alarms and/or notifications (such as by means of visual or auditory feedback) to an operator of the OEGS when the OEGS deviates from a desired positioning, heading and navigation, or if the system components are noy functioning properly.

Optionally, the dynamic positioning system is associated with a class thereof selected from at least one of: a dynamic positioning class 1, dynamic positioning class 2, a dynamic positioning class 3, a dynamic positioning class 4. Notably, the classification of the DP system in different classes is based on their capabilities and redundancy levels. The DP Class 1 represents the basic level of DP capability and is suitable for vessels engaged in operations where loss of position may result in acceptable levels of risk. DP Class 1 systems have a single fault tolerance, i.e., a failure of a single component does not result in the loss of position. The DP Class 2 systems offer a higher level of capability and redundancy compared to Class 1 and are intended for vessels that need to maintain position in more challenging environments or during operations with a higher risk profile. Such DP systems have a higher level of redundancy and are designed to withstand certain equipment failures without losing position. The DP Class 3 represents advanced DP capability and is suitable for vessels engaged in critical operations where loss of position could result in significant risk to life, the environment, or assets. Such systems have an even higher level of redundancy and are designed to handle multiple equipment failures without losing position. The DP Class 4 is the highest level of DP capability, so far, and are designed for vessels involved in specialized and high-risk operations, such as deep-sea drilling or installations in extreme environments. They have the highest level of redundancy and fault tolerance to ensure maximum safety and positioning accuracy. Notably, the different classification takes into account factors such as the vessel's intended operations, environmental conditions, redundancy of equipment, and system testing and verification. In this regard, each DP class has specific requirements for equipment, training, maintenance, and operational procedures. The classification ensures that vessels are adequately equipped and prepared to perform their intended tasks while maintaining safe and precise positioning. In an example, a vessel comprising more components that need controlling during operation may be equipped for a higher DP class compared to the vessel that contains only a single component.

Optionally, the dynamic positioning system is configured to structurally couple the floating facility, positioned via a first class of the dynamic positioning system, with another floating facility, positioned via a second class of the dynamic positioning system, resulting in an integrated floating facility, positioned via a third class of the dynamic positioning system, and wherein the third class is at least 20-30% superior to the first class and the second class. The term “structurally couple” indicates that the bows of the floating facility and the another floating facility are pointed in the same direction when coupled by the DP system. Herein, the first and second classes may be same or different, for example, the first class may be DP Class 1 and the second may be DP Class 2, in such case, the third class may result to be DP Class 3 or 4 which is at least 40% superior in terms of controlling the integrated floating facility comprising the floating facility and the another floating facility.

Optionally, the offshore energy generation system comprises mooring the floating facility, wherein mooring is selected from a spread mooring, a turret mooring, and wherein mooring employs a mooring system that connects the floating facility to any of: a seabed portion, a target site, the another floating facility, and wherein the mooring system is selected from at least one of: mooring lines, a turret equipment. In this regard, the floating facility is designed for mooring to a seabed portion. Herein, the term “mooring to a seabed portion” refers to an act of securing or anchoring the floating facility to a specific area of the seabed or ocean floor. Optionally, mooring connects, by way of physical structural coupling, the floating facility to any of: a seabed portion, a target site, the another floating facility. The ship-shaped, spar or semi-submersible type floating facility is kept in place by a mooring system. Typically, mooring of the floating facility to the seabed portion provides stability in the position of the floating facility relative to the seabed by preventing a potential drifting or movement thereof under various circumstances, such as earthquakes, tsunamis, high-tides, and so forth. Optionally, mooring may be achieved by using various mooring equipment such as anchors, chains, ropes, lines or cables, which are attached to both the object, i.e., the floating facility, and the seabed portion, a target site, the another floating facility. Depending on the water depth, oceanic and meteorologic conditions, there are two types of mooring method that could be selected: a spread mooring and a turret mooring. For both types of mooring system, spread and turret, mooring lines are required. The mooring lines are designed with a combination of chain and synthetic mooring lines, according to the design specific to the installation area.

Optionally, the mooring includes a spread mooring, and wherein the spread mooring employs mooring lines for connecting the floating facility to the seabed portion by means of suction piles, anchors or torpedoes anchors arranged along the seabed portion, where the mooring lines will be connected and properly tensioned between the floating facility and the seabed portion. The term “spread mooring” refers to a specific type of mooring that involves use of multiple mooring lines or cables that are spread out in different directions from the structure, namely, the floating facility, to the seabed portion. In this regard, the mooring lines are connected to the seabed portion by means of suction piles, regular anchors or torpedoes anchors that are arranged along the seabed portion on one end of the mooring lines and attached to the floating facility on the other. Beneficially, the spread mooring enable distributing the loads exerted by wind, waves, and currents over multiple points on the floating facility, thereby enhancing stability and minimizing stresses on the floating facility.

Throughout the present disclosure, the term “properly tensioned between the floating facility and the seabed portion” as used herein refers to a correct amount of tension or load to maintain the desired position (such as a fixed position) and stability of the floating facility relative to the seabed portion, to ensure safe and efficient operations thereof. Therefore, the mooring lines may be adjusted and maintained in a way that provides an appropriate amount of force to counteract the environmental forces acting on the floating facility. For example, if the mooring lines are too loose or under-tensioned, the floating facility may drift, leading to operational difficulties and safety risks. Alternatively, if the mooring lines are overly tight or over-tensioned, it could place unnecessary stress on the floating facility or the suction piles, the anchors or the torpedoes anchors arranged on the seabed portion, potentially leading to structural damage to the at least one of: the mooring lines, the floating facility, the suction piles, the anchors, the torpedoes anchors.

Optionally, the mooring comprises arranging mooring system on at least a part of perimeter of the floating facility and/or a bow region of the floating vessel on a first end thereof and to any of: a seabed portion, a target site, the another floating facility at a second end thereof, and wherein the part of perimeter of the floating facility is selected from: a forward-portside, a forward-starboard side, an aft-portside, and an aft-starboard side thereof.

In this regard, the spread mooring comprises arranging the mooring lines on at least a part of perimeter of the floating facility, wherein the part of perimeter of the floating facility is selected from: a forward-portside, a forward-starboard side, an aft-portside, and an aft-starboard side thereof. The ship-shaped floating facility is outfitted with a mooring equipment on each of the four corners (i.e., the forward-portside, the forward-starboard side, the aft-portside and the aft-starboard side) thereof, where the mooring lines will be connected and properly tensioned between the floating facility and the suction piles, the anchors or the torpedoes anchors arranged along the seabed portion. This floating facility mooring arrangement has an inherent flexibility that allows the floating facility to excursion within the operational limits of the whole offshore energy generation system. Moreover, the use of multiple anchor points also allows for flexibility of the floating facility in adapting to changing environmental conditions.

Moreover, optionally, the mooring includes a turret mooring, and wherein the turret mooring employs a turret equipment, arranged at a bow region of the floating facility, for connecting the floating facility to the seabed portion, and wherein an inner portion of the turret equipment is arranged with mooring lines, wherein the mooring lines are connected and properly tensioned between the floating facility and the seabed portion. The term “turret equipment” as used herein refers to a vertical (optionally, cylindrical or conical) structure located at the center of the floating facility or other floating vessels, such as a Floating Production Storage and Offloading (FPSO) vessel), and is designed to rotate freely. In the turret mooring, the bow of the ship-shaped floating facility (or the semi-submersible platform floating facility or the spar platform floating facility) is outfitted with the turret equipment. The turret equipment allows multiple 360 degrees free rotation of the floating facility around the center-point of the turret equipment, according to the prevailing weather (wind and ocean conditions), i.e., by maintaining a stable position relative to the seabed, with changing weather conditions, prevailing winds, and ocean currents. Beneficially, the turret equipment enables safe and efficient operation of the offshore energy generation system, as it offers flexibility and mobility, allowing the offshore energy generation system to be redeployed to different offshore fields once the production in a particular field declines or is completed.

Moreover, the mooring lines that are configured for connecting the floating facility to the seabed portion (similar as in the spread mooring), are attached to the turret equipment. Optionally, the mooring lines may be arranged in a radial pattern, extending outward from the turret equipment to anchor points on the seabed portion. The inner portion of the turret equipment is outfitted with a mooring equipment, where the mooring lines will be connected and properly tensioned. The mooring system, which consists of anchor lines or chains, of the turret equipment enables securing the offshore energy generation system to the seabed, to ensure that the offshore energy generation system remains stationary in the offshore field during production operations. Beneficially, the turret equipment allows the floating facility to rotate around its mooring point, thereby minimizing stresses on the mooring lines and ensures that the floating facility can align itself with prevailing wind, waves, and currents.

Optionally, the turret equipment is arranged internally or externally to the floating facility. The turret equipment could be installed internally (referred to as “internal turret equipment arrangement” hereafter) or externally (referred to as “external turret equipment arrangement” hereafter) to the ship-shaped floating facility (or the semi-submersible platform floating facility or the spar platform floating facility) based on any of: design preferences, technical requirements, and the specific needs of the offshore project. In the internal turret equipment arrangement, the turret equipment is located inside the floating facility to protect it from external elements, such as harsh weather and seawater. Beneficially, the internal turret equipment arrangement. Beneficially, the internal turret equipment arrangement provides enhanced safety and protection to the turret equipment, as well as results in a more compact and streamlined design for the offshore energy generation system. In the external turret equipment arrangement, the turret equipment is located outside the floating facility through a swivel system that allows rotational movement and alignment of the floating facility with the prevailing environmental forces. Herein, the swivel system allows the floating facility to rotate around the turret equipment point during normal operations, thereby reducing the effects of environmental forces on the floating facility. Beneficially, the external turret equipment arrangement provides more space in the floating facility layout for larger components or systems (or sub-systems) of the offshore energy generation system. Moreover, external turret equipment arrangement provides simplified access to the turret equipment, making maintenance and repairs more convenient.

Optionally, the turret equipment is implemented as a disconnectable turret equipment. Typically, the disconnectable turret equipment allows the floating facility to temporarily disconnect itself from the subsea infrastructure, including the mooring system (and risers, if any), and move to a safe location during severe weather conditions. For example, in case the offshore energy generation system is installed in a hurricane area, disconnectable turret equipment is selected for mooring. Beneficially, the disconnectable turret equipment has an inherent flexibility that allows the floating facility excursion within the operational limits of the offshore energy generation system. Additionally, beneficially, the disconnectable turret equipment reduces the risk of damage to the mooring lines, risers, and other subsea components. It will be appreciated that the disconnectable turret equipment comprises a plurality of disconnecting couplings that couple the disconnectable turret equipment and the mooring lines, to enable a rapid and safe disconnection of the mooring lines when needed, with minimal manual intervention.

Optionally, the offshore energy generation system is designed to provide any combination of electric power and/or ammonia and/or freshwater and/or hydrogen (H₂). In this regard, the offshore energy generation system provides an integrated offshore facility capable of generating multiple products and services from different energy sources, such as electric power and other valuable products including freshwater, ammonia, hydrogen, oxygen. It will be appreciated that based on the size of the offshore energy generation system and the requirements of the end consumer, the offshore energy generation system may be designed to provide an altered integrated offshore facility, such as that producing a combination of the above-mentioned products, such as electricity and freshwater or electricity and ammonia or electricity and hydrogen, freshwater and ammonia or freshwater and hydrogen, ammonia and hydrogen, freshwater and electricity and ammonia, and so forth, based on the energy sources and technologies utilized. In this regard, one or more components (or system) of the offshore energy generation system are operatively coupled with each other to generate different forms of green-energy, selected from electric power, hydrogen, nitrogen, ammonia, steam and freshwater. Herein, the term “operatively coupled” relates to use of an end product (or a by-product) on one system by another system, that is operatively coupled to the previous system, as at least one of: a starting material, a catalyst, a process condition. Beneficially, the integrated approach allows for a more efficient and sustainable use of resources, as different components of the offshore energy generation system can complement each other and optimize energy production and utilization. Moreover, the combination of electricity, ammonia, and freshwater production may address multiple needs while minimizing environmental impacts.

The process starts with a high heat generation reaction by the steam generation system. The heat generated by the steam generation system is transferred to the water surrounding the steam generation system. The water surrounding the steam generation system is circulated through a heat exchanger, and it never enters in contact with a secondary heating medium of the heat exchanger. Steam is generated in the secondary heating medium of the steam generation system. The steam generated by the steam generation system is conditioned and directed to a steam turbine where high voltage electrical power will be generated by the electric power generation system.

The heat generating source technology chosen to power at least one of the steam generation system and the electric power generation system could be nuclear fusion, nuclear fission or Hydrogen (H₂) fuel cell. All of them are viable solutions for generating heat or power. Nuclear fusion and nuclear fission are related to nuclear energy, while hydrogen fuel cells rely on chemical reactions involving hydrogen. The latter (namely, the (H₂) fuel cell) require a simpler system once electricity is produced directly from the fuel cell, excluding the requirement of steam handling and steam turbines.

Moreover, the offshore energy generation system is outfitted with cooling water system comprising multiple redundant emergency pumps and fail-open valves that ensures constant source of cooling water medium (i.e., seawater) to the heat generating source employed (used) by the electric power generation system, in order to avoid overheating and further damages thereto.

The steam that leaves the steam turbine is also used in the process of freshwater distillation by the freshwater generation system. The freshwater system is configured to heat the seawater collected by the seawater collection system using the residual heat generated by the steam generation system. Optionally, the freshwater generation system may further comprise a dehumidification arrangement that is configured to convert vapors of freshwater into liquid distilled freshwater. From the step of freshwater distillation at the freshwater generation system, the remaining (namely, the residual) steam will be utilized to drive a machinery and will be returned to the beginning of the process (namely, steam generation system) for further recirculation thereof.

Nitrogen (N₂) is generated onboard via the electrically driven nitrogen (N₂) generation system, that may be one of the commercially available nitrogen (N₂) generation systems. Hydrogen (H₂) is generated onboard utilizing a fraction of the freshwater produced by the freshwater generation system, via electrolysis process. Hydrogen (H₂) is generated by the Hydrogen (H₂) generation system, electrically driven by the electric power generation system. In this regard, the Hydrogen (H₂) generation system will be supplied with electrolysis and the freshwater distilled by the freshwater generation system as the inputs of the Hydrogen (H₂) generation system. Combining the hydrogen (H₂) and the nitrogen (N₂) in the ammonia (NH₃) generation system, we'll have a carbon-free energy source, namely ammonia (NH₃).

Moreover, the offshore energy generation system also comprises a set of export systems, namely, the electric power export system, the freshwater export system, and the ammonia export system, and hydrogen export system for exporting the generated energy sources or products, namely, the electric power, the freshwater, and the ammonia (NH₃), and the hydrogen, from the offshore energy generation system to onshore, offshore or other subsea systems to reach end consumers thereof, via at least one of: subsea electric power export lines or cables and subsea freshwater pipelines and subsea ammonia pipelines, and subsea hydrogen pipelines respectively. The subsea pipeline or cable connects the ship-shaped floating facility (or the semi-submersible platform floating facility or the spar platform floating facility) and is laid on the seabed until it reaches the shoreline where it's connected to receiving facilities, such as a freshwater city-grid, an ammonia storage facility, or a city power grid, for further processing and distribution.

Optionally, the offshore or subsea systems are selected from at least one of: offshore oil and gas production systems, offshore marine terminals, offshore ports, offshore industrial, offshore recreational parks, offshore and/or underwater computer data centers, aerospace offshore facilities, and offshore fish and food processing. This receiving substation, if needed could be located onshore, or in other offshore systems, such as offshore oil and gas production systems, e.g., spars, semi-submersibles, FPSO (Floating, Production, Storage and Offloading), etc. The offshore oil and gas production systems are installations located at sea to extract oil and natural gas from beneath the seabed by employing drilling rigs, platforms, and floating production facilities. The offshore oil and gas industry include spars, semi-submersibles, and Floating, Production, Storage, and Offloading (FPSO) for various stages of exploration, production, and transportation. Typically, the spars are floating offshore platforms used for the production of oil and gas from subsea wells. The semi-submersibles are floating platforms with multiple buoyant hulls (pontoons) connected to a deck structure above the waterline, for drilling operations and exploration activities in deep water or harsh sea conditions. The FPSO are mobile floating vessel used in offshore oil and gas production, used for processing, storing, and offloading oil and gas produced from subsea wells. It has production facilities, storage tanks, and offloading equipment on board.

The offshore marine terminals are facilities used for loading and unloading cargo, such as oil, liquefied natural gas (LNG), or other goods, from ships or tankers in deep water locations. The offshore ports are artificial islands or structures built at sea to serve as docking and loading points for ships, and support maritime activities. The offshore industrial facilities are industrial activities and installations, including offshore manufacturing, construction, renewable energy installations (e.g., offshore wind farms), and other industrial processes, conducted at sea. The offshore recreational parks are recreational facilities, such as amusement parks or resorts, built on artificial islands or floating structures in coastal or marine areas. The offshore and underwater computer data centers involve the placement of data centers underwater or on artificial islands at sea, to leverage the surrounding water for cooling, reducing energy consumption and carbon footprint generated thereby. The aerospace offshore facilities may include launch sites or platforms used for launching rockets, satellites, or conducting aerospace-related research and activities at sea. The offshore fish and food processing facilities involve the processing and storage of seafood and food products at sea or on floating platforms.

Optionally, the electric power, generated by the electric power generation system, is exported to at least one of: shore, offshore or subsea systems, via subsea electric power export lines. The subsea electric power export lines or cable connects to the offshore energy generation system and is laid on the seabed until t reaches the shoreline, or other offshore systems, where it's connected to the receiving substation for further conditioning and distribution to the consumers.

Optionally, the distilled freshwater, from the freshwater generation system, is exported to at least one of: shore, offshore or subsea systems, via freshwater pipelines and/or other marine vessels. The freshwater, generated from the seawater in the freshwater generation system, will be conditioned and stored in freshwater tanks associated with the offshore energy generation system, for further processing and exportation, via freshwater pipelines and/or other marine vessels (such as tankers or barges), to the end consumer thereof. Brine will be returned to the ocean. The storage tanks layout and design are similar to the regular tanker ships found in the market today. The freshwater pipelines can be laid underground, underwater, or a combination of both, depending on the geographical and logistical considerations. Beneficially, the freshwater exportation through freshwater pipelines or marine vessels allows addressing water scarcity in regions with limited access to water resources, such as areas facing droughts or other water-related challenges, or for supporting economic development and meeting the water demands of industries and populations in need thereof.

Optionally, the ammonia, generated by the ammonia generation system, is exported to at least one of: shore, or offshore or subsea systems, via ammonia pipelines and/or other marine vessels. Ammonia (NH₃) is exported to shore via subsea ammonia pipelines that connects the ship-shaped floating facility (or the semi-submersible platform floating facility or the spar platform floating facility) to a receiving terminal for ammonia at the at least one of: shore, or offshore or subsea systems. The ammonia (NH₃) could be exported in liquid or gaseous phase, depending on the capabilities of the receiving customer. The receiving shore terminal processes the ammonia (NH₃) further for sales and distribution.

Optionally, the hydrogen, generated by the hydrogen generation system, is exported to at least one of: shore, offshore or subsea systems, via subsea hydrogen pipeline. The subsea hydrogen pipeline connects to the offshore energy generation system and is laid on the seabed until it reaches the shoreline, or other offshore systems, where it's connected to the receiving unit for further distribution to the consumers.

Oxygen (O₂) is a by-product from the nitrogen (N₂) generation system and the hydrogen (H₂) generation system and is to be safely vented to the atmosphere.

The offshore energy generation system is outfitted with electrical transformers to condition the power for exportation. The power exported could be alternated current (AC) or direct current (DC), depending on the power level and the distance between the offshore energy generation system and the substation onshore, or at the offshore consumer.

Optionally, the offshore energy generation system further comprises a freshwater storage tank and/or an ammonia storage tank operatively coupled to the freshwater export system and the ammonia export system, respectively. Optionally, the freshwater export system is implemented as a freshwater export pumps system to collect and transfer the freshwater from the freshwater storage tanks to the freshwater pipeline that connects to the freshwater city grid. Additionally, the freshwater storage tanks serve the purpose to regulate the freshwater export flow and as an emergency secondary heat-sink system to cooldown the heat generation system. The freshwater storage tank volume will depend on the operator's preference, could range from 0 hours of storage to multiple days.

Optionally, the offshore energy generation system further comprises a freshwater conditioning system operatively coupled to the freshwater storage tank, wherein the freshwater conditioning system is selected from: a mineralization system and a chlorination system. The freshwater conditioning system typically is a sub-system integrated into the offshore energy generation system, specifically designed to treat and condition the stored freshwater. In this regard, the freshwater conditioning system may be installed in-between the freshwater generation system and the freshwater storage tank, such that the freshwater generated by the freshwater generation system is first treated in the freshwater conditioning system and the treated freshwater is then directly introduced into the freshwater storage tank. Alternatively, the freshwater conditioning system is arranged in-between the freshwater storage tank and the freshwater city grid, to allow the freshwater to be extracted from the freshwater storage tank and then treated before use by the end consumer thereof. The mineralization system typically adds essential minerals and trace elements to the stored freshwater, to improve the freshwater's nutritional content, making it suitable for specific applications, such as aquaculture, agriculture, or drinking water for humans and livestock. The chlorination system typically involves adding chlorine or chlorine-based compounds to disinfect the water and kill harmful microorganisms, including bacteria and viruses, to ensure the safety and potability of drinking water and to prevent the growth of harmful pathogens in the stored freshwater. Beneficially, the freshwater conditioning system enables improving the quality and suitability of the stored freshwater for various applications.

Similarly, the Ammonia (NH₃) export system is provided with the ammonia storage tanks to collect and transfer the ammonia to the ammonia pipeline that connects to the consumers. Optionally, the freshwater storage tank and/or an ammonia storage tank are installed onboard the offshore energy generation system or on a facility that is operatively coupled to the offshore energy generation system.

Optionally, in case of the turret mooring, the electric power export lines, the freshwater pipelines, the ammonia pipeline, the hydrogen pipeline and/or other marine vessels pass through the turret equipment and are laid on the seabed. The turret equipment houses several important components, including swivels, bearings, and fluid transfer systems. These components enable the transfer of products between the facilities, such as FPSO and the subsea production wells, as well as the offloading tankers. The electrical power export line, the freshwater, the hydrogen pipeline and Ammonia export lines pass inside the turret equipment and is laid on the seabed until they reach the consumers. It will be appreciated that routing the aforementioned export system components through the turret equipment and laying them on the seabed is intended to optimize the efficiency and safety of the transport process. Moreover, the turret equipment allows the offshore floating facility to rotate and align with changing conditions, ensuring that the pipelines and export lines or cables remain properly connected and secure while adapting to environmental forces. Laying the export system components on the seabed provides a stable and protected pathway for the transportation of electricity, freshwater, ammonia, hydrogen and other products from the offshore facility to their end consumers or distribution points.

Furthermore, the offshore energy generation system comprises the multiple offshore cranes; living quarters; and the helideck arranged on the floating facility. The ship-shaped floating facility (or the semi-submersible platform floating facility or the spar platform floating facility) is to be outfitted with suitable accommodations for the crew living onboard, optionally, in a rotation scheme. Helideck to be outfitted on the top of the accommodation in order to allow transportation of people and small parts. Optionally, the helideck is outfitted directly on a floor section of the floating facility. Offshore cranes suitable for regular operation and special maintenance are to be outfitted on both sides of the ship-shaped floating facility (or the semi-submersible platform floating facility or the spar platform floating facility). Optionally, other systems like lighting, air conditioning, compressed air, sewage, firefighting, navigational aids, entertainment, ballast, hot water, and others required by flag State, International Labor Organization and Classification Societies are to be installed to assure safety of man onboard the offshore energy generation system.

Furthermore, the offshore energy generation system comprises an automation, control and safety system for controlling one or more components of the offshore energy generation system. Advanced automation and control technology is to be utilized to control all the processes onboard the ship-shaped floating facility. Additionally, encrypted remote control capabilities are installed to enable control from the central control room located in a designated location onshore, where the operator has offices. Safe, reliable and secure remote control is archived by the selection of power cable outfitted with multicore fiber optics, which enables direct connection to the operator's network infrastructure.

Optionally, the offshore energy generation system further comprises a data center with computing and networking equipment for collecting, storing, processing, distributing, and/or allowing access to data or operations for telecommunications, internet or blockchain technologies for crypto currency operations. Notably, the aforementioned extended features of the offshore energy generation system integrate a data center with the traditional energy production and product transportation components, for efficient management, real-time monitoring, and optimization of the offshore facility's performance. Herein, the term “data center” refers to a facility equipped with high-performance computing and networking equipment that is responsible for various data-related operations such as data collection, processing, storage, and communication. Optionally, the data includes, but is not limited to, production data, operational metrics, environmental measurements. In this regard, the data center collects and stores data generated by the offshore energy generation system and other connected systems or sub-systems thereof. The computing resources in the data center process the collected data to derive insights, perform analyses, and optimize the operation of the offshore energy generation system. Moreover, the data center facilitates the distribution of processed data to various users or systems, both onboard the offshore platform and onshore, and allows authorized personnel, operators, or external entities to access and utilize the collected and processed data for monitoring, control, reporting, and decision-making purposes. The data center is equipped to handle telecommunications and internet-related operations, enabling communication between the offshore facility and onshore locations, as well as access to the global internet network. The data center employs the data to be used in blockchain technologies, which are decentralized and secure digital ledgers used for recording cryptocurrency transactions and other data in a tamper-proof manner. Beneficially, the data centers enable remote monitoring and control, predictive maintenance, and data-driven decision-making to enhance the overall reliability and productivity of the offshore energy production and distribution processes.

Optionally, for increased protection, the ship-shaped floating facility (or the semi-submersible platform floating facility or the spar platform floating facility) is outfitted with an emergency generator capable to sustain emergency systems in operation for a period of 21 days with intensive automation and remote control as described above. The offshore energy generation system is also outfitted with an uninterruptable power system (UPS) that is able to sustain emergency systems operations for few minutes while the emergency generator is automatically started and put online.

The ship-shaped floating facility (or the semi-submersible platform floating facility or the spar platform floating facility) is outfitted with the isolation technology called “double hull” on the critical areas (side shell and bottom), according to the state of art shipbuilding current standards.

The ship-shaped floating facility (or the semi-submersible platform floating facility or the spar platform floating facility) is yet designed to be built in a regular shipyard, where the integration of the heat generator system will be carried out. The heat generating equipment supplier will deliver the system in large parts for further integration with the ship-shaped floating facility (or the semi-submersible platform floating facility or the spar platform floating facility). The offshore energy generation system is also designed to be wet towed or dry-transported from the shipyard to the final operation location and later at the end of the design life, from the operation to the scrap yard or any other relocation required during the life of the asset.

The ship-shaped floating facility design life is between 20 and 60 years with major maintenance during the operational life. It will be appreciated that the design life of the semi-submersible platform floating facility or the spar platform floating facility may be similar or different from the ship-shaped floating facility. Optionally, the design life of the semi-submersible platform floating facility or the spar platform floating facility may range from 10 to 30 years, depending on several factors, including engineering considerations, materials used, maintenance practices, and specific requirements of the offshore energy project.

The offshore energy generation system is scalable from micro to giga generators and as many redundancy sub-systems as required by the client and regulatory authorities, which will drive the size of the ship-shaped floating facility (or the semi-submersible platform floating facility or the spar platform floating facility).

Beneficially, the offshore energy generation system is a zero-carbon facility that does not generate any type of hydrocarbons such as methanol, jet fuel and others. The offshore energy generation system also generates hydrogen for its internal processes and delivers the remaining amount of generated hydrogen as a product to the consumers. Moreover, the offshore energy generation system is not limited to the use of nuclear fission for electricity generation as it can generated from nuclear fusion or Hydrogen (H₂) fuel cell, or a combination thereof.

### DETAILED DESCRIPTION OF THE DRAWINGS

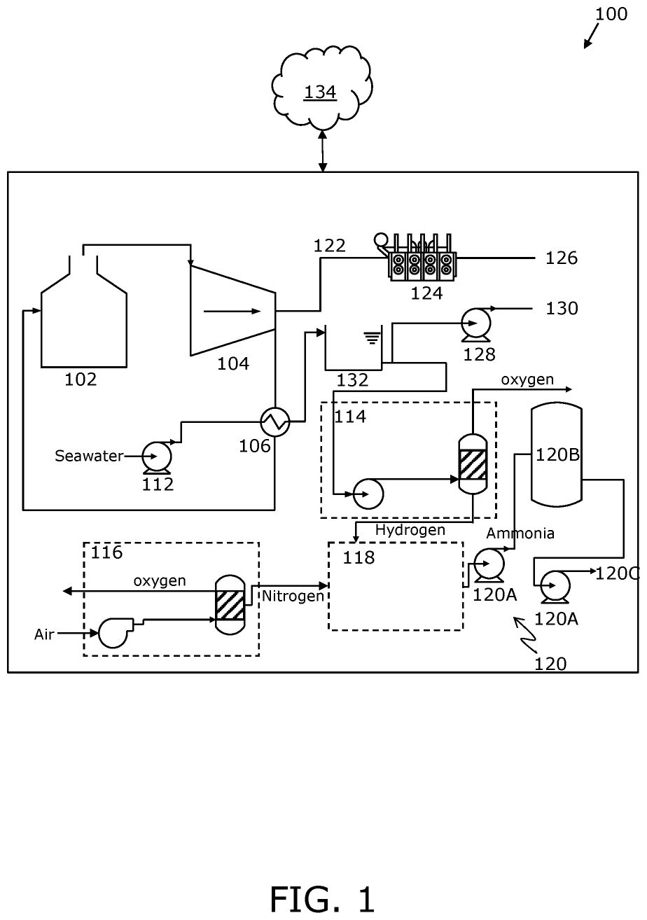

Referring to FIG. 1, illustrated is a high-level schematic process view of an offshore energy generation system 100. As shown, the steam generation system 102 feeds steam to an electric power generation system 104 (comprising a steam turbine) for electric power generation.

The steam coming out the electric power generation system 104 is further used for seawater distillation process to generate freshwater by the freshwater generation system 106. The remaining steam (not represented) could be used to power certain machines, as an example the freshwater export system 108, ammonia (NH₃) export system 110, seawater collection system 112, and others. From a fraction of the freshwater generated onboard, hydrogen (H₂) is generated via water electrolysis in a hydrogen (H₂) generation system 114; nitrogen (N₂) is generated via commercially available nitrogen (N₂) generation system 116 (by utilizing atmospheric air). The oxygen generated from the hydrogen (H₂) generation system 114 and the nitrogen (N₂) generation system 116 is vented out into the atmosphere. Utilizing the hydrogen (H₂) and the nitrogen (N₂), ammonia (NH₃) is generated by the ammonia (NH₃) generation system 118, and exported to shore via ammonia (NH₃) export system 120 that comprises pumps or compressors 120A, an ammonia storage tank 120B, and ammonia pipeline 120C, in liquid or gaseous form. The generated electric power is exported via electric power export lines or cables 122 to a substation 124 from where the electric power is supplied to end consumers via DC/AC high voltage export lines 126.

The distilled freshwater is exported to shore via a freshwater export system 128 and a freshwater pipeline 130. As shown, a freshwater storage tank 132 is arranged between the freshwater generation system 106 and the freshwater export system 128, configured to store the distilled freshwater before it is exported for use by end user or for electrolysis thereof to generate hydrogen (H₂). As shown, both the hydrogen (H₂) generation system 114 and the nitrogen (N₂) generation system 116 comprise a set of pumps 114A and 116A and storage tanks 114B and 116B thereof, respectively, configured to store the input materials for generation of ammonia (NH₃) thereby. The dynamic positioning system 134, communicably coupled to the floating facility of the offshore energy generation system 100, is configured for positioning the floating facility at a target site.

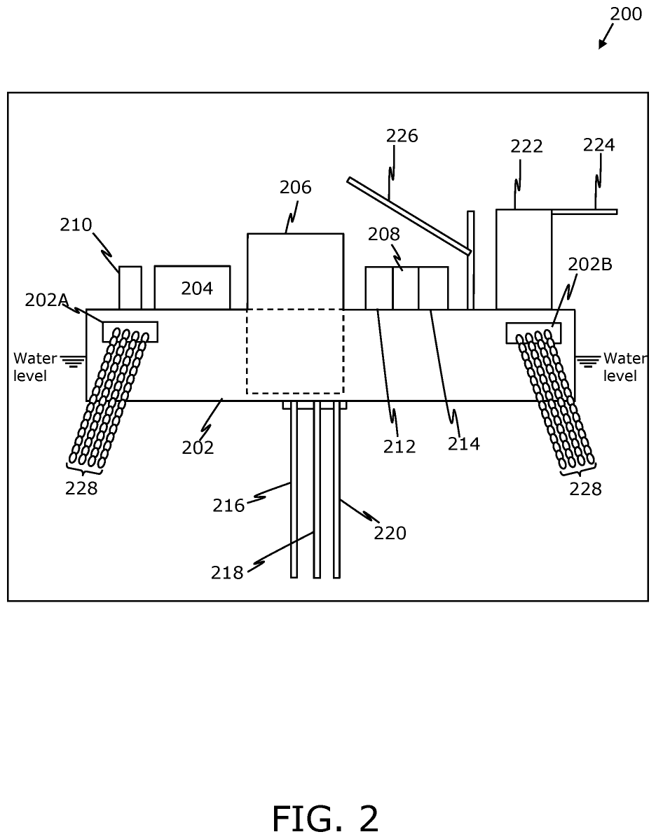

Referring to FIG. 2, illustrated is a schematic profile view of main components of an offshore energy generation system 200 moored using spread mooring. As shown the offshore energy generation system 200 comprises a floating facility 202, a steam generation system 204, an electric power generation system 206, a freshwater generation system 208, a hydrogen generation system 210, a nitrogen generation system 212, an ammonia generation system 214, an electric power export line 216, a freshwater pipeline 218, an ammonia pipeline 220, accommodations 222, a helipad 224, an overboard crane 226, and mooring lines 228 connected to a forward-portside 202A and an aft-portside 202B on the outer perimeter (or boundary) of the floating facility 202 on one end and a seabed portion on the other end thereof. As shown, the mooring lines 228 are properly tensioned between the floating facility 202 and the seabed portion.

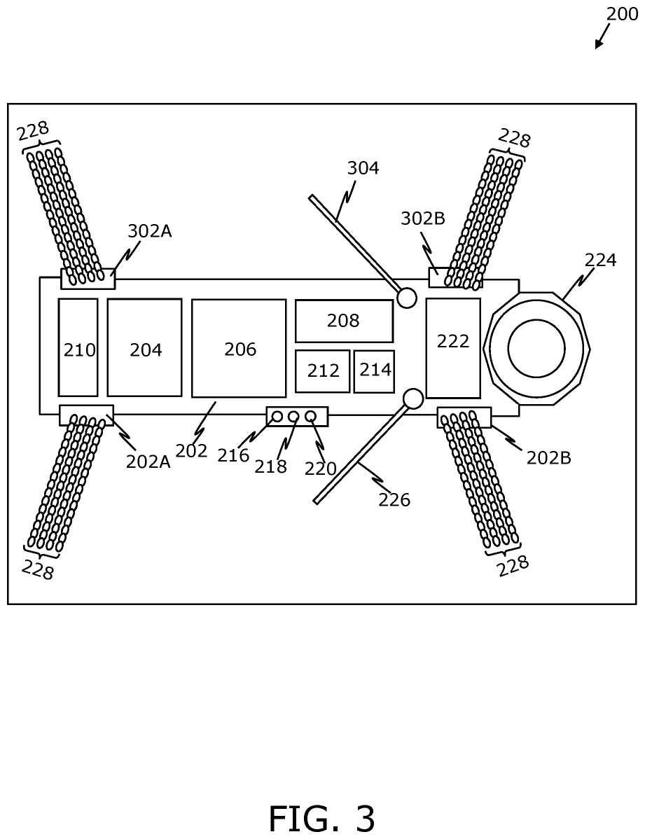

Referring to FIG. 3, illustrated is a schematic plan view of main components of an offshore energy generation system 200, moored using spread mooring. As shown, the mooring lines 228 are further connected to a forward-starboard side 302A and an aft-starboard side 302B, besides the forward-portside 202A and the aft-portside 202B on the outer perimeter (or boundary) of the floating facility 202 on one end and the seabed portion 230 on the other end thereof. As shown, the forward-starboard side 302A and the aft-starboard side 302B are arranged on the outer perimeter (or boundary) of the floating facility 202 opposite to the forward-portside 202A and the aft-portside 202B respectively. As shown, the mooring lines 228 are properly tensioned between the floating facility 202 and the seabed portion 230. Also, there is shown presence of an onboard crane 304 in addition to the overboard crane 226.

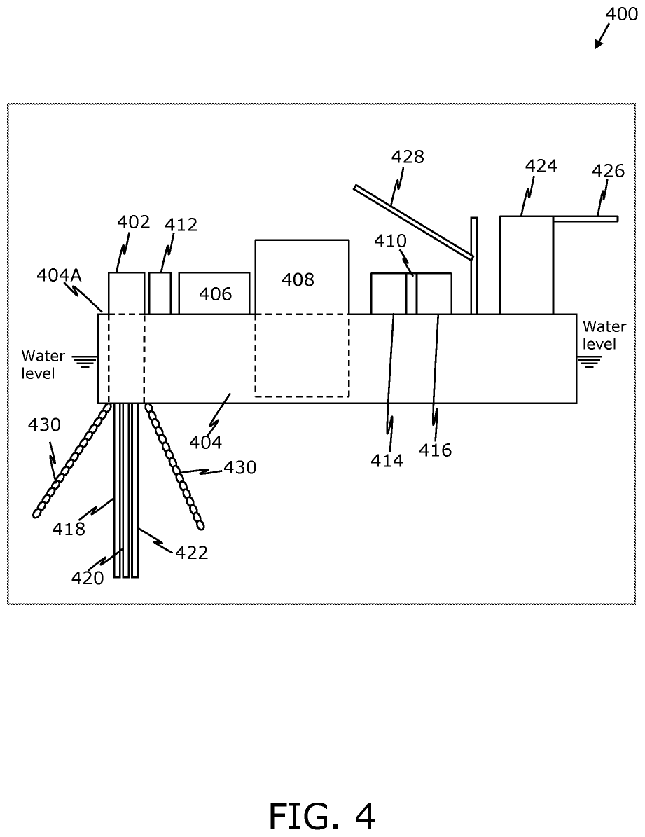

Referring to FIG. 4, illustrated is a schematic profile view of main components of an offshore energy generation system 400, moored using a turret equipment 402. As shown the offshore energy generation system 400 comprises a floating facility 404, a steam generation system 406, an electric power generation system 408, a freshwater generation system 410, a hydrogen generation system 412, a nitrogen generation system 414, an ammonia generation system 416, an electric power export line 418, a freshwater pipeline 420, an ammonia pipeline 422, accommodations 424, a helipad 426, an overboard crane 428, and the turret equipment 402. As shown, the turret equipment 402 is arranged on a bow region 404A of the floating facility the floating facility 404. As shown, the electric power export line 418, the freshwater pipeline 420, and the ammonia pipeline 422 pass through the turret equipment 402 and are laid on the seabed. As shown, the turret equipment 402 is arranged with mooring lines 430, wherein the mooring lines 430 extend outward from the turret equipment 402 to a seabed portion.

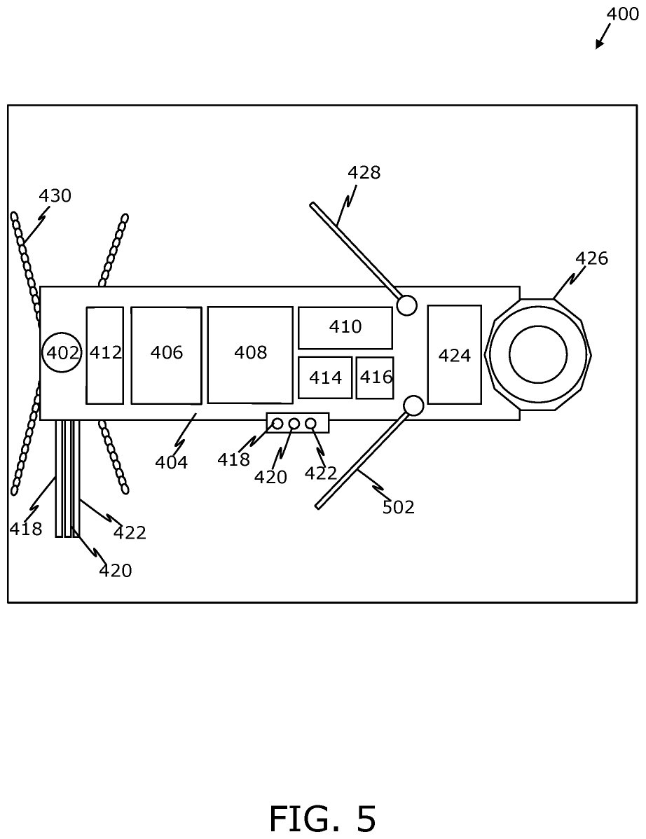

Referring to FIG. 5, illustrated is a schematic plan view of main components of an offshore energy generation system 100, moored using a turret equipment 402. As shown, the mooring lines 436 connected the turret equipment 402 and the seabed portion 438 from 4 sides of the turret equipment 402. Herein, the 4 sides are arranged corresponding to a forward-portside 404A, an aft-portside 404B a forward-starboard side 404C, and an aft-starboard side 404D of the floating facility 404. As shown, the mooring lines 436 are properly tensioned between the turret equipment 402 and the seabed portion 438. As shown, the electric power export line 418, the freshwater pipeline 420, and the ammonia pipeline 422 are also provided straight from floating facility 404 and are laid on the seabed. Also, there is shown presence of an onboard crane 502 in addition to the overboard crane 428.

What is claimed is:

1. An offshore energy generation system comprising:
a floating facility configured for dynamic positioning at a target site, the floating facility is coupled with
a seawater collection system arranged on the floating facility and configured for collecting a volume of seawater;
a steam generation system, operatively coupled with the seawater collection system, configured for generating steam from the volume of seawater collected by the seawater collection system;
an electric power generation system, operatively coupled with the steam generation system, configured for generating electric power by using at least one of: the steam generated by the steam generation system, a nuclear fission, a nuclear fusion, a hydrogen (H2) fuel cell;
a freshwater generation system, operatively coupled with the seawater collection system and the steam generation system, configured for distilling freshwater by using the volume of seawater collected by the seawater collection system and a residual thermal energy generated by the steam generation system;
a hydrogen (H2) generation system, operatively coupled with the freshwater generation system and the electric power generation system, configured for generating hydrogen by using the distilled freshwater from the freshwater generation system and the electric power generated by the electric power generation system;
a nitrogen (N2) generation system, operatively coupled with the electric power generation system, configured for generating nitrogen by using compressed air from an air supply unit and the electric power generated by the electric power generation system;
an ammonia generation system, operatively coupled with the electric power generation system, the hydrogen (H2) generation system and the nitrogen (N2) generation system, configured for generating ammonia by using the hydrogen (H2), the nitrogen (N2) and the electric power generated by the hydrogen generation system, the nitrogen generation system and the electric power generation system, respectively;
a cooling water system, operatively coupled to the electric power generation system and the seawater collection system, configured for supplying the volume of seawater collected by the seawater collection system to the electric power generation system;
an electric power export system, operatively coupled to the electric power generation system, configured for exporting the generated electric power;
a freshwater export system, operatively coupled to the freshwater generation system, configured for exporting the distilled freshwater;
an ammonia export system, operatively coupled to the ammonia generation system, configured for exporting the generated ammonia;
multiple offshore cranes arranged on the floating facility;
living quarters arranged on the floating facility;
a helideck arranged on the floating facility; and
an automation, control and safety system for controlling one or more components of the offshore energy generation system; and
a dynamic positioning system, communicably coupled to the floating facility, for positioning the floating facility at the target site.

2. The offshore energy generation system according to claim 1, wherein the dynamic positioning system is associated with a class thereof selected from at least one of: a dynamic positioning class 1, dynamic positioning class 2, a dynamic positioning class 3, a dynamic positioning class 4.

3. The offshore energy generation system according to claim 2, wherein the dynamic positioning system is configured to structurally couple the floating facility, positioned via a first class of the dynamic positioning system, with another floating facility, positioned via a second class of the dynamic positioning system, resulting in an integrated floating facility, positioned via a third class of the dynamic positioning system, and wherein the third class is at least 20-30% superior to the first class and the second class.

4. The offshore energy generation system according to claim 1, wherein the dynamic positioning system comprises position reference sensors, environmental sensors, one or more processors, a control arrangement, and a monitoring system.

5. The offshore energy generation system according to claim 4, wherein the one or more processors is configured to implement an algorithm thereon, to control a positioning of the floating facility via thrusters and/or propellers corresponding to the floating facility, based on a mathematical model of the floating facility.

6. The offshore energy generation system according to claim 1, further comprising mooring the floating facility, wherein mooring is selected from a spread mooring, a turret mooring, and wherein mooring employs a mooring system that connects the floating facility to any of: a seabed portion, a target site, the another floating facility, and
wherein the mooring system is selected from at least one of: mooring lines, a turret equipment.

7. The offshore energy generation system according to claim 6, wherein the mooring comprises arranging mooring system on at least a part of perimeter of the floating facility and/or a bow region of the floating vessel on a first end thereof and to any of: a seabed portion, a target site, the another floating facility at a second end thereof, and
wherein the part of perimeter of the floating facility is selected from: a forward-portside, a forward-starboard side, an aft-portside, and an aft-starboard side thereof.

8. The offshore energy generation system according to claim 7, wherein the turret equipment is arranged internally or externally to the floating facility.

9. The offshore energy generation system according to claim 7, wherein the turret equipment is implemented as a disconnectable turret equipment.

10. The offshore energy generation system according to claim 7, wherein electric power export lines, freshwater pipelines, ammonia pipeline and/or other marine vessels pass through the turret equipment and are laid on the seabed.

11. The offshore energy generation system according to claim 1, wherein the distilled freshwater, generated by the freshwater generation system, is exported to at least one of: shore, or other offshore or subsea systems, via freshwater pipelines and/or other marine vessels.

12. The offshore energy generation system according to claim 11, wherein the ammonia, generated by the ammonia generation system, is exported to at least one of: shore, or other offshore or subsea systems, via ammonia pipelines and/or other marine vessels.

13. The offshore energy generation system according to claim 11, wherein the hydrogen, generated by the hydrogen generation system, is exported to at least one of: shore, or other offshore or subsea systems, via hydrogen pipelines and/or other marine vessels.

14. The offshore energy generation system according to claim 11, wherein the electric power, generated by the electric power generation system, is exported to at least one of: shore, or other offshore or subsea systems, via electric power export lines.

15. The offshore energy generation system according to claim 11, wherein the offshore or subsea systems are selected from at least one of: offshore oil and gas production systems; offshore marine terminals, ports, industrial, recreational parks; offshore and/or underwater computer data centers, aerospace offshore facilities, offshore fish and food processing.

16. The offshore energy generation system according to claim 1, wherein the offshore energy generation system is designed to provide any combination of electric power and/or ammonia and/or freshwater and/or hydrogen.

17. The offshore energy generation system according to claim 1, further comprising a data center with computing and networking equipment for collecting, storing, processing, distributing, and/or allowing access to data or operations for telecommunications, internet or blockchain technologies for crypto currency operations.

18. The offshore energy generation system according to claim 1, further comprising a freshwater storage tank and/or an ammonia storage tank operatively coupled to the freshwater export system and the ammonia export system, respectively.

19. The offshore energy generation system according to claim 18, further comprising a freshwater conditioning system operatively coupled to the freshwater storage tank, wherein the freshwater conditioning system is selected from: a mineralization system and a chlorination system.
